(19) United States
(12) Patent Application Publication
(10) Pub. No.: US 2013/0241866 A1
(43) Pub. Date: Sep. 19, 2013

(54) RESISTIVE MULTI-TOUCH CONTROLLER

(71) Applicants: Ing-Yih Wang, Tucson, AZ (US); Herbert Braisz, Tucson, AZ (US)

(72) Inventors: Ing-Yih Wang, Tucson, AZ (US); Herbert Braisz, Tucson, AZ (US)

(73) Assignee: Texas Instruments Incorporated, Dallas, TX (US)

(21) Appl. No.: 13/435,634

(22) Filed: Mar. 30, 2012

Related U.S. Application Data
(60) Provisional application No. 61/610,738, filed on Mar. 14, 2012.

(51) Int. Cl. G06F 3/045

(52) U.S. Cl. 345/174

(57) ABSTRACT

An apparatus is provided. The apparatus comprises a touch screen interface and a signal processing circuit. Within the touch screen interface, there are switching circuits, where each switching circuit is configured to be coupled to a column electrode, and there are touch detection circuits, where each touch detection circuit is configured to be coupled to a row electrode. The signal processing circuit is then coupled to each switching circuit and each touch detection circuit so as to be able to selectively activate the plurality of switching circuits and the plurality of touch detection circuits to identify a zone for a touch event. Also, the signal processing circuit is configured to determine first, second, third, and fourth resistances for the zone for the touch event and is configured to determine a set of coordinates and pressure for the touch event from its first, second, third, and fourth resistances.

### CROSS-REFERENCE TO RELATED APPLICATIONS

This application claims priority to U.S. Patent Application Ser. No. 61/610,738, filed on Mar. 14, 2012, which is hereby incorporated by reference for all purposes.

### TECHNICAL FIELD

The invention relates generally to a touch screen controller and, more particularly, to a resistive touch screen controller.

### BACKGROUND

Turning to FIG. 1, an example of a conventional 4-wire interface system 100 can be seen. When a touch event occurs on the touch screen 102, the pressure applied to the touch screen 102 allows the column and row sheets of the touch screen 102 to intersect at the location of the touch event. To resolve this location, the touch screen interface 108 (which generally resides in the touch screen controller 104 and which can include drivers and switches) is able to selectively activate the row sheet or column sheet of the touch screen 102 so as to allow the analog-to-digital converter (ADC) 112 (which can, for example, be a successive approximation register (SAR) ADC) to measure the resistances of the row and column sheets. The pre-processing circuit 114 is then able to store the measured (and digitized) resistances and interpolate the position of the touch event on the touch screen 102. This interpolated position can then be passed to the host processor 106 though the host interface 116.

With these types of systems (i.e., system 100), there are some drawbacks. First, it is difficult to resolve multiple, simultaneous touch events with conventional 4-wire or 5-wire systems, usually requiring sophisticated algorithms to resolve the multiple, simultaneous touch events. Second, interpolation within the pre-processing circuit 114 can be costly in terms of power consumption and/or area. Therefore, there is a need for an improved resistive touch screen controller.

Some other conventional systems are: U.S. Pat. No. 6,492,979; U.S. Pat. No. 6,504,530; PCT Publ. No. WO2010117946; PCT Publ. No. WO2011087669; and Rick Downs, “Using resistive touch screens for human/machine interface,” TI Analog Applications Journal, Third Quarter 2005.

### SUMMARY

An embodiment of the present invention, accordingly, provides a method for determining respective first and second positions for first and second touch events that are substantially simultaneous on a touch screen having a plurality of zones. The method comprises identifying a first zone of the plurality of zones, wherein the first zone is associated with the first touch event; resolving the first position in the first zone by: activating a first column and a first row so as to measure first, second, third, and fourth resistances associated with the first touch event; generating a first digital representation for a first set of coordinates on the touch screen and a first pressure from a set of the first, second, third, and fourth resistances; storing the first digital representation; and deactivating the first column and the first row; identifying a second zone of the plurality of zones, wherein the second zone is associated with the second touch event; and resolving the second position in the second zone by: activating a second column and a second row so as to measure fifth, sixth, seventh, and eighth resistances associated with the second touch event; generating a second digital representation for a second set of coordinates on the touch screen and a second pressure from the fifth, sixth, seventh, and eighth resistances; storing the second digital representation; and deactivating the second column and the second row.

In accordance with an embodiment of the present invention, the step of identifying the first zone further comprises performing a precharge and sensing operation for all zones to indicate the occurrence of the first touch event, and wherein the step of identifying the second zone further comprises performing a precharge and sensing operation for all zones to indicate the occurrence of the second touch event.

In accordance with an embodiment of the present invention, the step of generating a first digital representation further comprises: calculating a horizontal position in the first zone corresponding to the first touch event from the first resistance, wherein the horizontal position corresponds to a first coordinate from the first set of coordinates; calculating a vertical position in the first zone corresponding to the first touch event from the second resistance, wherein the vertical position corresponds to a second coordinate from the first set of coordinates; calculating a touch resistance from the horizontal position, the first resistance, the third resistance, and the fourth resistance; and calculating the first pressure from the touch resistance.

In accordance with an embodiment of the present invention, the step of generating a first digital representation further comprises: calculating a horizontal position in the first zone corresponding to the first touch event from the first resistance, wherein the horizontal position corresponds to a first coordinate from the first set of coordinates; calculating a vertical position in the first zone corresponding to the first touch event from the second resistance, wherein the vertical position corresponds to a second coordinate from the first set of coordinates; calculating a touch resistance from the horizontal position, the vertical position, the first resistance, the second resistance, the third resistance, and the fourth resistance; and calculating the first pressure from the touch resistance.

In accordance with an embodiment of the present invention, an apparatus is provided. The apparatus comprises a touch screen interface having: a plurality of switching circuits, wherein each switching circuit is configured to be coupled to at least one of a plurality of column electrodes; and a plurality of touch detection circuits, wherein each touch detection circuit is configured to be coupled to at least one of a plurality of row electrodes; and a signal processing circuit that is coupled to each switching circuit and each touch detection circuit, wherein the signal processing circuit is configured to selectively activate the plurality of switching circuits and the plurality of touch detection circuits to identify a zone for a touch event, and wherein the signal processing circuit is configured to determine first, second, third, and fourth resistances for the zone for the touch event, and wherein the signal processing circuit is configured to determine a set of coordinates and pressure for the touch event from its first, second, third, and fourth resistances.

In accordance with an embodiment of the present invention, the signal processing circuit is configured to calculate: a horizontal position in the zone corresponding to the touch event from the first resistance, wherein the horizontal position corresponds to a first coordinate from the set of coordinates; a vertical position in the zone corresponding to the touch event from the second resistance, wherein the vertical position corresponds to a second coordinate from the set of coordinates; a touch resistance from the horizontal position, the first resistance, the third resistance, and the fourth resistance; and the first pressure from the touch resistance.

In accordance with an embodiment of the present invention, the signal processing circuit further comprises: a multi-touch controller that is coupled to the touch screen interface; and a touch engine that is coupled to the touch screen interface and the multi-touch controller.

In accordance with an embodiment of the present invention, the signal processing circuit further comprises a host interface that is coupled to the touch engine.

In accordance with an embodiment of the present invention, the touch engine further comprises: an analog-to-digital converter (ADC) that is coupled to the plurality of touch detection circuits; a touch engine controller that is coupled to the multi-touch controller, the ADC, and the host interface; and a pre-processing circuit that is coupled to the touch engine controller and the host interface.

In accordance with an embodiment of the present invention, the host interface further comprises: an index register for storing the zone for the touch event; and a data register for storing digital representations of the first, second, third, and fourth resistances for the touch event.

In accordance with an embodiment of the present invention, an apparatus is provided. The apparatus comprises a touch screen having: a plurality of column electrodes; and a plurality of row electrodes; a touch screen controller having: a touch screen interface having: a plurality of switching circuits, wherein each switching circuit is coupled to at least one of the column electrodes; and a plurality of touch detection circuits, wherein each touch detection circuit is coupled to at least one of the row electrodes; and a signal processing circuit that is coupled to each switching circuit and each touch detection circuit, wherein the signal processing circuit is configured to selectively activate the plurality of switching circuits and the plurality of touch detection circuits to identify a zone for a touch event, and wherein the signal processing circuit is configured to determine first, second, third, and fourth resistances for the zone for the touch event, and wherein the signal processing circuit is configured to determine a set of coordinates and pressure for the touch event from the first, second, third, and fourth resistances; and a host processor that is coupled to the signal processing circuit.

In accordance with an embodiment of the present invention, the host interface further comprises an inter-integrated circuit (I2C) interface that is coupled to the host processor.

In accordance with an embodiment of the present invention, the touch screen has three columns and five rows.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of an example of a conventional interface system;

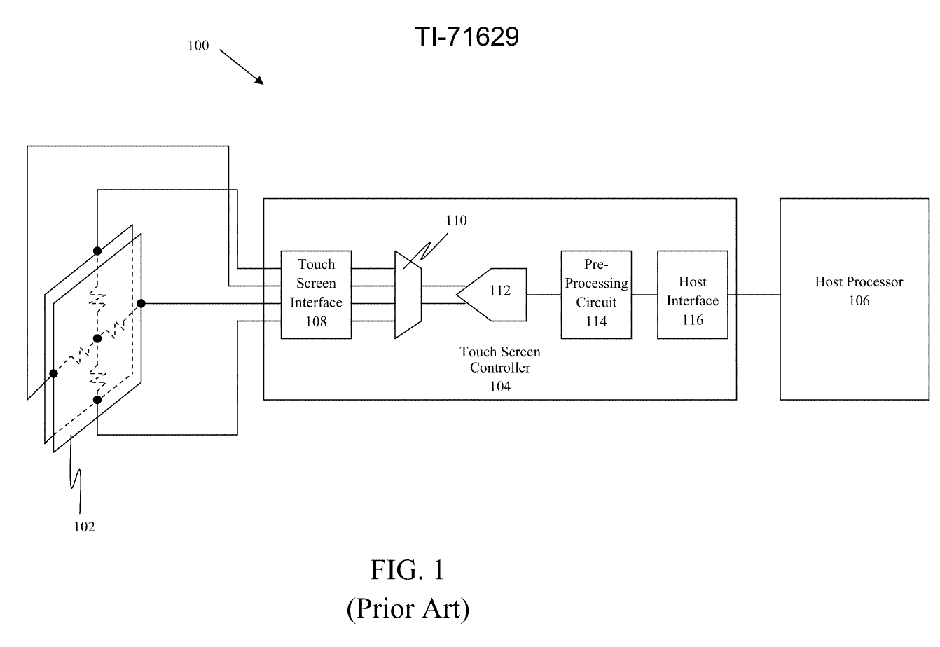

FIG. 2 is a diagram of an interface system in accordance with the present invention;

FIG. 3 is a diagram illustrating an example of the touch screen of FIG. 2;

FIG. 4 is a diagram of an example of the touch screen interface of FIG. 2;

FIG. 5 is a diagram illustrating the touch engine and host interface of FIG. 2; and

FIG. 6 is a state diagram for the signal processing circuit of the touch screen controller of FIG. 2.

### DETAILED DESCRIPTION

Refer now to the drawings wherein depicted elements are, for the sake of clarity, not necessarily shown to scale and wherein like or similar elements are designated by the same reference numeral through the several views.

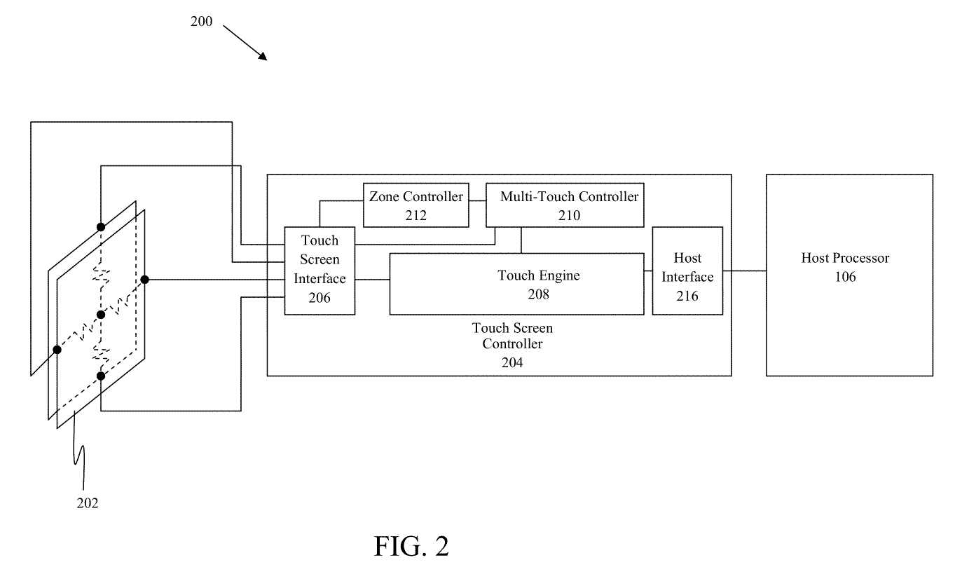

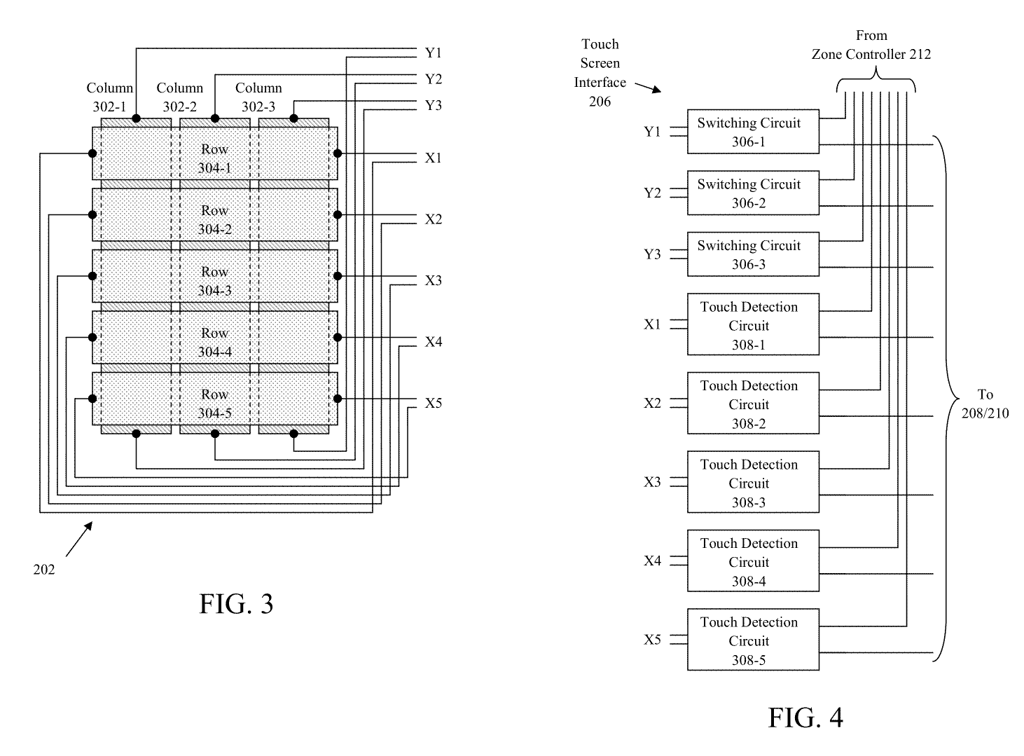

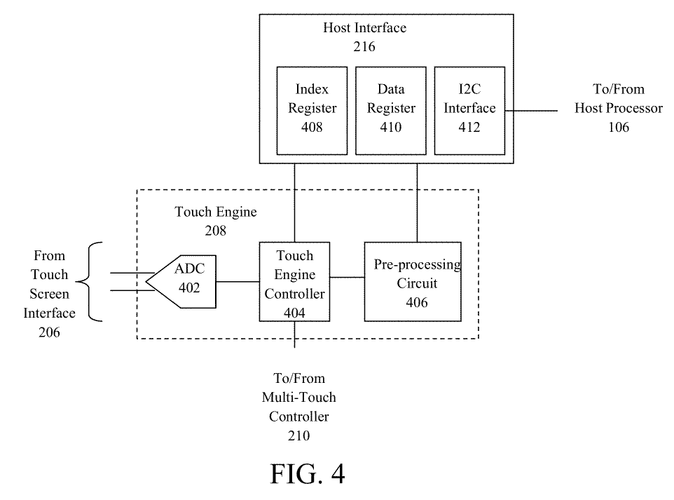

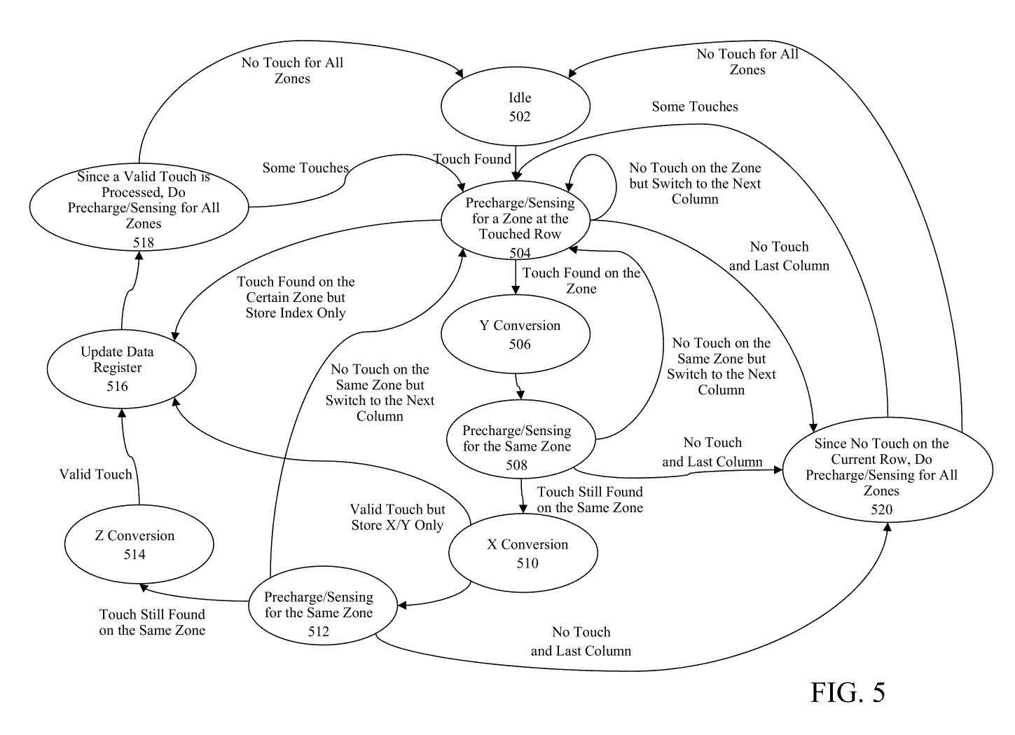

As shown in FIGS. 2-4, the touch screen 202 and touch screen interface 206 of interface system 200 have a different configuration than that of the touch screen 102 and interface 108 of system 100. In this example, the touch screen 202 is divided into a number of column electrodes 302-1 to 302-3 and row electrodes 304-1 to 304-5 that are formed resistive sheets. In this example, there are three column electrodes (i.e., 302-1 to 302-3) and five row electrodes (i.e. 304-1 to 304-5), but other numbers of row and column electrodes are possible. For example, the number of row electrodes and/or column electrodes may be increased to increase resolution by increasing the number of “zones” (i.e., intersections of column and row electrodes). Coupled to each column electrode 302-1 to 302-3 is a switching circuit 306-1 to 306-3 (which generally resides in the touch screen interface 206 of the touch screen controller 204 and which also generally includes drivers to assist in sourcing current through the respective column electrodes), and coupled to each row electrode 304-1 to 304-5 is a touch detection circuit 308-1 to 308-5 (which generally resides in the touch screen interface 206 of the touch screen controller 204 and which also generally includes drivers and switches to assist in sourcing current through the respective row electrodes). By configuring the touch screen 202 and touch screen interface 206 as shown, the touch screen 202 can be better controlled; specifically, the signal processing circuit of touch screen controller 204 (which can generally comprise zone controller 212, touch engine 208, multi-touch controller 210 and host interface 216) is able to coarsely determine the “zone” of a touch event and finely resolve the position within the zone using the circuitry shown in FIG. 4 and the state diagram of FIG. 5. It should also be noted that the host interface 216 can be a variety of different interfaces, such as inter-integrated circuit (I2C), Universal Asynchronous Receiver/Transmitter (UART), and so forth.

Initially, in state 502, the signal processing circuit is at an idle state. While in state 502, the signal processing circuit can perform a precharge and sensing operation to determine whether a touch event (anywhere on the touch screen 202 has occurred). This is typically done by activating (with the multi-touch controller 210) all switching circuits 306-1 to 306-3 and all touch detection circuits 308-1 to 308-5 or by repeatedly scanning through the switching circuits 306-1 to 306-3 and touch detection circuits 308-1 to 308-5. This allows for coarse identification of the “zone” or intersecting row and column electrodes having a touch event. This zone can then be stored in the index register 408 of the host interface 216.

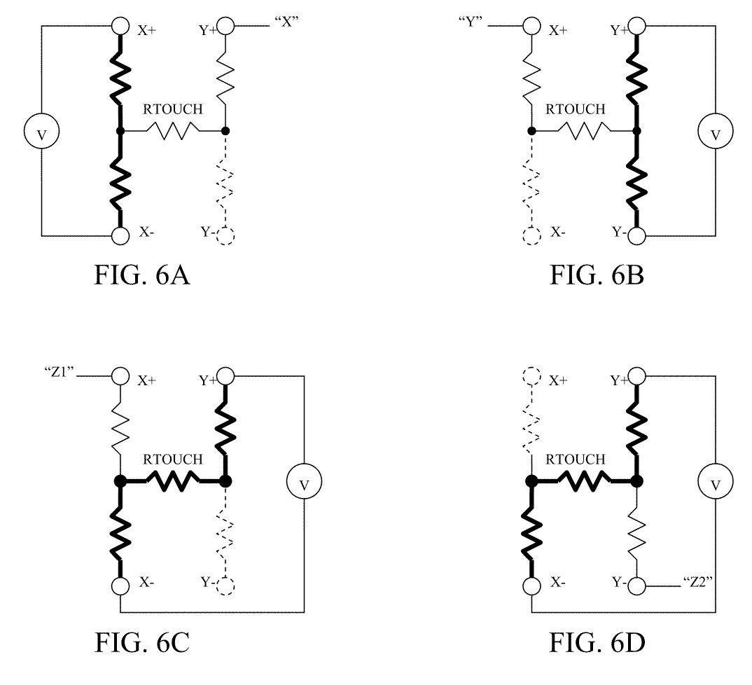

When the zone for a touch event has been identified, the characteristics of the touch can be resolved. Specifically, in state 504, the signal processing circuit (by way of the zone controller 212 and multi-touch controller 210) can perform a precharge and sensing operation for the column associated with the identified zone. Typically, the signal processing circuit activates or applies a voltage (i.e., voltage V) across the column electrode (i.e., 302-1) associated with the zone (as shown in FIG. 6B), and a resistance measurement is performed by the touch detection circuit (i.e., 308-1) associated with the zone. This strip resistance R_{Y} (which corresponds to the associated column) can be converted by ADC 402, touch engine controller 404, and pre-processing circuit 406 in state 506 to a digital representation of the vertical (or “Y”) coordinate within the identified zone, which can be stored in data register 410 in state 516. Then, in state 508, the signal processing circuit can perform a precharge and sensing operation for the row associated with the identified zone. Typically, the signal processing circuit activates or applies a voltage (i.e., voltage V) across the row electrode (i.e., 304-1) associated with the zone (as shown in FIG. 6A), and a resistance measurement is performed by the touch detection circuit (i.e., 308-1) associated with the zone. This strip resistance R_{X} (which corresponds to the associated row) can be converted by ADC 402, touch engine controller 404, and pre-processing circuit 406 in state 510 to a digital representation of the horizontal (or “X”) coordinate within the identified zone, which can be stored in data register 410 in state 516. In some circumstances (i.e., where no pressure measurement is desired), state 516 can be entered from state 510.

In instances where a pressure measurement is desired, the pressure (or “Z” coordinate) can be determined in states 512 and 514 and stored in the data register 410 in state 516. (after a determination that there has been no change in the zone in state 512). To do this, two resistance measurements are made. As shown in FIGS. 6C and 6D, a voltage V is applied across the positive terminal for the column electrode associated with the identified zone (i.e., 302-1) and the negative terminal for the row electrode associated with the identified zone (i.e., 304-1). The first pressure-related resistance measurement Z1 is then determined from the positive terminal for the row electrode associated with the identified zone (i.e., 304-1), and the second pressure-related resistance measurement Z2 is determined from the negative terminal for the column electrode associated with the identified zone (i.e., 302-1). With these resistance measurements, the touch resistance RTOUCH can be calculated as follows:

$$\begin{matrix}RTOUCH = {R}_{X} \frac{X}{4096} ( \frac{Z 2}{Z 1} - 1 ) ; \\ or & ( 1 ) \\ RTOUCH = {R}_{X} \frac{X}{4096} ( \frac{4096}{Z 1} - 1 ) - {R}_{Y} ( 1 - \frac{Y}{4096} ) , & ( 2 )\end{matrix}$$

where X is the horizontal position or coordinate within the identified zone, Y is the vertical position or coordinate within the identified zone, R_{X} and R_{Y} are the strip resistances, and Z1 and Z2 are the pressure-related resistance measurements. The touch resistance RTOUCH is inversely proportional to the pressure applied to the touch screen, so the ADC 402, touch engine controller 404, and pre-processing circuit 406 in state 514 can both calculate the touch resistance RTOUCH and pressure, which can be stored in data register 410 in state 516.

Following the update of the data register 410 with the pressure (or “Z”) coordinate, the signal processing circuit can perform a precharge and sensing operation to determine whether a touch event anywhere else on the touch screen 202 has occurred in state 518. States 504 to 516 can then be repeated for additional touch events and other zones. Additionally, because interaction with a touch screen 202 in interactive, touch events change, as, for example, fingers are moved across the touch screen, the state diagram includes several state changes reflecting these types of changes. With most of the state changes, the columns and/or rows can be switched or cycled (i.e., activations of successive column electrodes 302-1 to 302-3 and/or row electrodes 304-1 to 304-5).

Thus, by using the system 200, several benefits can be realized. First, power consumption can be reduced over that of system 100. Second, multi-touch capability (i.e., between difference zones) can be realized without the use of more exotic algorithms.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. A method for determining respective first and second positions for first and second touch events that are substantially simultaneous on a touch screen having a plurality of zones, the method comprising:
identifying a first zone of the plurality of zones, wherein the first zone is associated with the first touch event;
resolving the first position in the first zone by:
activating a first column and a first row so as to measure first, second, third, and fourth resistances associated with the first touch event;
generating a first digital representation for a first set of coordinates on the touch screen and a first pressure from a set of the first, second, third, and fourth resistances;
storing the first digital representation; and
deactivating the first column and the first row;
identifying a second zone of the plurality of zones, wherein the second zone is associated with the second touch event; and
resolving the second position in the second zone by:
activating a second column and a second row so as to measure fifth, sixth, seventh, and eighth resistances associated with the second touch event;
generating a second digital representation for a second set of coordinates on the touch screen and a second pressure from the fifth, sixth, seventh, and eighth resistances;
storing the second digital representation; and
deactivating the second column and the second row.

2. The method of claim 1, wherein the step of identifying the first zone further comprises performing a precharge and sensing operation for all zones to indicate the occurrence of the first touch event, and wherein the step of identifying the second zone further comprises performing a precharge and sensing operation for all zones to indicate the occurrence of the second touch event.

3. The method of claim 2, wherein the step of generating a first digital representation further comprises:
calculating a horizontal position in the first zone corresponding to the first touch event from the first resistance, wherein the horizontal position corresponds to a first coordinate from the first set of coordinates;
calculating a vertical position in the first zone corresponding to the first touch event from the second resistance, wherein the vertical position corresponds to a second coordinate from the first set of coordinates;
calculating a touch resistance from the horizontal position, the first resistance, the third resistance, and the fourth resistance; and
calculating the first pressure from the touch resistance.

4. The method of claim 2, wherein the step of generating a first digital representation further comprises:
calculating a horizontal position in the first zone corresponding to the first touch event from the first resistance, wherein the horizontal position corresponds to a first coordinate from the first set of coordinates;
calculating a vertical position in the first zone corresponding to the first touch event from the second resistance, wherein the vertical position corresponds to a second coordinate from the first set of coordinates;
calculating a touch resistance from the horizontal position, the vertical position, the first resistance, the second resistance, the third resistance, and the fourth resistance; and
calculating the first pressure from the touch resistance.

5. An apparatus comprising:
a touch screen interface having:
a plurality of switching circuits, wherein each switching circuit is configured to be coupled to at least one of a plurality of column electrodes; and
a plurality of touch detection circuits, wherein each touch detection circuit is configured to be coupled to at least one of a plurality of row electrodes; and
a signal processing circuit that is coupled to each switching circuit and each touch detection circuit, wherein the signal processing circuit is configured to selectively activate the plurality of switching circuits and the plurality of touch detection circuits to identify a zone for a touch event, and wherein the signal processing circuit is configured to determine first, second, third, and fourth resistances for the zone for the touch event, and wherein the signal processing circuit is configured to determine a set of coordinates and pressure for the touch event from its first, second, third, and fourth resistances.

6. The apparatus of claim 5, wherein the signal processing circuit is configured to calculate:
a horizontal position in the zone corresponding to the touch event from the first resistance, wherein the horizontal position corresponds to a first coordinate from the set of coordinates;
a vertical position in the zone corresponding to the touch event from the second resistance, wherein the vertical position corresponds to a second coordinate from the set of coordinates;
a touch resistance from the horizontal position, the first resistance, the third resistance, and the fourth resistance; and
the first pressure from the touch resistance.

7. The apparatus of claim 6, wherein the signal processing circuit further comprises:
a multi-touch controller that is coupled to the touch screen interface; and
a touch engine that is coupled to the touch screen interface and the multi-touch controller.

8. The apparatus of claim 7, wherein the signal processing circuit further comprises a host interface that is coupled to the touch engine.

9. The apparatus of claim 8, wherein the touch engine further comprises:
an analog-to-digital converter (ADC) that is coupled to the plurality of touch detection circuits;
a touch engine controller that is coupled to the multi-touch controller, the ADC, and the host interface; and
a pre-processing circuit that is coupled to the touch engine controller and the host interface.

10. The apparatus of claim 9, wherein the host interface further comprises:
an index register for storing the zone for the touch event; and
a data register for storing digital representations of the first, second, third, and fourth resistances for the touch event.

11. An apparatus comprising:
a touch screen having:
a plurality of column electrodes; and
a plurality of row electrodes;
a touch screen controller having:
a touch screen interface having:
a plurality of switching circuits, wherein each switching circuit is coupled to at least one of the column electrodes; and
a plurality of touch detection circuits, wherein each touch detection circuit is coupled to at least one of the row electrodes; and
a signal processing circuit that is coupled to each switching circuit and each touch detection circuit, wherein the signal processing circuit is configured to selectively activate the plurality of switching circuits and the plurality of touch detection circuits to identify a zone for a touch event, and wherein the signal processing circuit is configured to determine first, second, third, and fourth resistances for the zone for the touch event, and wherein the signal processing circuit is configured to determine a set of coordinates and pressure for the touch event from the first, second, third, and fourth resistances; and
a host processor that is coupled to the signal processing circuit.

12. The apparatus of claim 11, wherein the signal processing circuit is configured to calculate:
a horizontal position in the zone corresponding to the touch event from the first resistance, wherein the horizontal position corresponds to a first coordinate from the set of coordinates;
a vertical position in the zone corresponding to the touch event from the second resistance, wherein the vertical position corresponds to a second coordinate from the set of coordinates;
a touch resistance from the horizontal position, the first resistance, the third resistance, and the fourth resistance; and
the first pressure from the touch resistance.

13. The apparatus of claim 12, wherein the signal processing circuit further comprises:
a multi-touch controller that is coupled to the touch screen interface; and
a touch engine that is coupled to the touch screen interface and the multi-touch controller.

14. The apparatus of claim 13, wherein the signal processing circuit further comprises a host interface that is coupled between the touch engine and the host processor.

15. The apparatus of claim 14, wherein the touch engine further comprises:
an analog-to-digital converter (ADC) that is coupled to the plurality of touch detection circuits;
a touch engine controller that is coupled to the multi-touch controller, the ADC, and the host interface; and
a pre-processing circuit that is coupled to the touch engine controller and the host interface.

16. The apparatus of claim 15, wherein the host interface further comprises:
an index register for storing the zone for the touch event; and
a data register for storing digital representations of the first, second, third, and fourth resistances for the touch event.

17. The apparatus of claim 16, wherein the host interface further comprises an inter-integrated circuit (I2C) interface that is coupled to the host processor.

18. The apparatus of claim 17, wherein the touch screen has three columns and five rows.
